(19) United States
(12) Patent Application Publication
(10) Pub. No.: US 2026/0254794 A1
(43) Pub. Date: Aug. 27, 2026

(54) MARKET-SPECIFIC PROVIDER ELECTRONIC DEVICES

(71) Applicant: JPMORGAN CHASE BANK, N.A., New York, NY (US)

(72) Inventors: Tuan DAO, Richardson, TX (US); Howard SPECTOR, Street, MD (US)

(21) Appl. No.: 19/548,158

(22) Filed: Feb. 24, 2026

Related U.S. Application Data
(60) Provisional application No. 63/762,963, filed on Feb. 25, 2025.

(51) Int. Cl. H04L 9/40; G06F 21/53

(52) U.S. Cl. CPC H04L 63/0272; G06F 21/53; G06F 2221/2149

(57) ABSTRACT

According to another embodiment, a method may include: receiving, by a market-specific provider application executed by an electronic device and from a user, a search; calling, by the market-specific provider application, a market-specific provider server with the search; anonymizing, by the market-specific provider server, a digital fingerprint for the user; retrieving, by the market-specific provider server, generic search results from a third-party server; filtering, by the market-specific provider server, the generic search results using financial data and/or a user profile for the user; accessing, by the market-specific provider server, a database of offers, wherein the offers comprise discounts or reward point earning opportunities; enriching, by the market-specific provider server, the filtered generic search results with the offers; and returning, by the market-specific provider server, the filtered generic search results enriched with the offers to the market-specific provider application.

### RELATED APPLICATIONS

This application claims priority to, and the benefit of, U.S. Provisional Patent Application Ser. No. 63/762,963, filed February 25, 2025, the disclosure of which is hereby incorporated, by reference, in its entirety.

### BACKGROUND OF THE INVENTION

### 1. Field of the Invention

Embodiments relate to market-specific provider electronic devices.

### 2. Description of the Related Art

Regardless of the operating system run by a user’s mobile electronic device, such as a smartphone, there are at least three main entities that have an interest in collecting the user’s data: the device manufacturer, the operating system provider, and the owner of the applications running on the device. Thus, users cannot be sure that any of their data is kept strictly private.

### SUMMARY OF THE INVENTION

Market-specific provider electronic devices are disclosed. In an embodiment, an electronic device may include: a central processing unit; a memory storing an operating system, a third-party application, and firmware; a secure execution environment associated with a market-specific provider and comprising a market-specific provider application, wherein the operating system, the third-party application, and the firmware cannot access data in the secure execution environment; and communications hardware in communication with the secure execution environment via a virtual private network (VPN). The VPN provides an interface for the market-specific provider application in the secure execution environment to securely communicate with a market-specific provider server without the operating system or the third-party application accessing user data in the secure execution environment.

In an embodiment, the firmware further comprises market-specific provider firmware that is configured to prevent other firmware or the operating system from activating certain hardware.

In an embodiment, the operating system is provided by the market-specific provider.

In an embodiment, the market-specific provider application is configured to: receive, from a user, a search; call the market-specific provider server with the search; receive results of the search, wherein the results are enriched with offers; and receive a selection of one of the results.

According to another embodiment, a method may include: receiving, by a market-specific provider application executed by an electronic device and from a user, a search; calling, by the market-specific provider application, a market-specific provider server with the search; anonymizing, by the market-specific provider server, a digital fingerprint for the user; retrieving, by the market-specific provider server, generic search results from a third-party server; filtering, by the market-specific provider server, the generic search results using financial data and/or a user profile for the user; accessing, by the market-specific provider server, a database of offers, wherein the offers comprise discounts or reward point earning opportunities; enriching, by the market-specific provider server, the filtered generic search results with the offers; and returning, by the market-specific provider server, the filtered generic search results enriched with the offers to the market-specific provider application.

In an embodiment, the digital fingerprint comprises an electronic device identifier, a user identifier, and/or user account information.

In an embodiment, the market-specific provider application comprises a market-specific provider map application.

In an embodiment, the market-specific provider application comprises a market-specific provider search engine.

In an embodiment, the market-specific provider server filters the generic search results according to a user intent.

In an embodiment, the user intent is based on a transaction history for the user, a financial profile for the user, and/or spending patterns for the user.

In an embodiment, the user intent is deduced from the search.

In an embodiment, the market-specific provider application overlays the offers over the generic search results.

In an embodiment, the method may also include: receiving, by the market-specific provider application, a selection of an offer; recording, by the market-specific provider server, the offer to an associated payment mechanism; and applying, by the market-specific provider server, the offer to a transaction involving a qualifying purchase.

According to another embodiment a system may include: a user electronic device comprising a computer processor and executing a market-specific provider application in a secure execution environment; and a market-specific provider server in communication with the market-specific provider application via a virtual private network. The market-specific provider application is configured to receive, from a user, a search; the market-specific provider application is configured to call the market-specific provider server with the search; the market-specific provider server is configured to anonymize a digital fingerprint for the user; the market-specific provider server is configured to retrieve generic search results from a third-party server; the market-specific provider server is configured to filter the generic search results using financial data and/or a user profile for the user; the market-specific provider server is configured to access a database of offers, wherein the offers comprise discounts or reward point earning opportunities; the market-specific provider server is configured to enrich the filtered generic search results with the offers; the market-specific provider server is configured to return the filtered generic search results enriched with the offers to the market-specific provider application; and the market-specific provider application is configured to overlay the offers over the generic search results.

In an embodiment, the digital fingerprint comprises an electronic device identifier, a user identifier, and/or user account information.

In an embodiment, the market-specific provider application comprises a map application.

In an embodiment, the market-specific provider server filters the generic search results according to a user intent.

In an embodiment, the user intent is based on a transaction history for the user, a financial profile for the user, spending patterns for the user, and/or products or services used by the user.

In an embodiment, the user intent is deduced from the search.

In an embodiment, the market-specific provider application is configured to receive a selection of an offer; the market-specific provider server is configured to record the offer to an associated payment mechanism; and the market-specific provider server is configured to apply the offer to a transaction involving a qualifying purchase.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a market-specific provider electronic device according to an embodiment;

FIG. 2 depicts an exemplary implementation of a secure execution environment on a market-specific provider electronic device according to an embodiment;

FIGS. 3A and 3B depict exemplary user search actions using an application in a secure execution environment of a market-specific provider electronic device according to another embodiment; and

FIG. 4 depicts a method for executing a search using an application in a secure execution environment of a market-specific provider electronic device according to an embodiment.

### DETAILED DESCRIPTION OF PREFERRED EMBODIMENTS

Embodiments are directed to market-specific provider electronic devices.

Embodiments may focus user interaction to a single private market-specific provider device, may protect customer data and privacy, may provide secure communication channel, may provide the ability to execute agreements, e-signatures, etc., may provide enhanced private market-specific provider functionalities and values, may facilitate faster products/services introduction and/or adjustment, may enable feature-based releases, deep-linked applications, and single sign on (SSO), and may secure the provider as a “first party” or “zero party.”

A “first party” may be an entity that can infer the user’s intent, for example, from user actions. A “zero party” is an entity that the user trusts enough to provide personally identifiable information (PII) or the user’s intent. For example, a financial institution may be a zero party for banking services, and a first party for dining.

Although embodiments may be described in the context of financial institutions and financial applications, it should be noted that this is illustrative only and the application is not so limited.

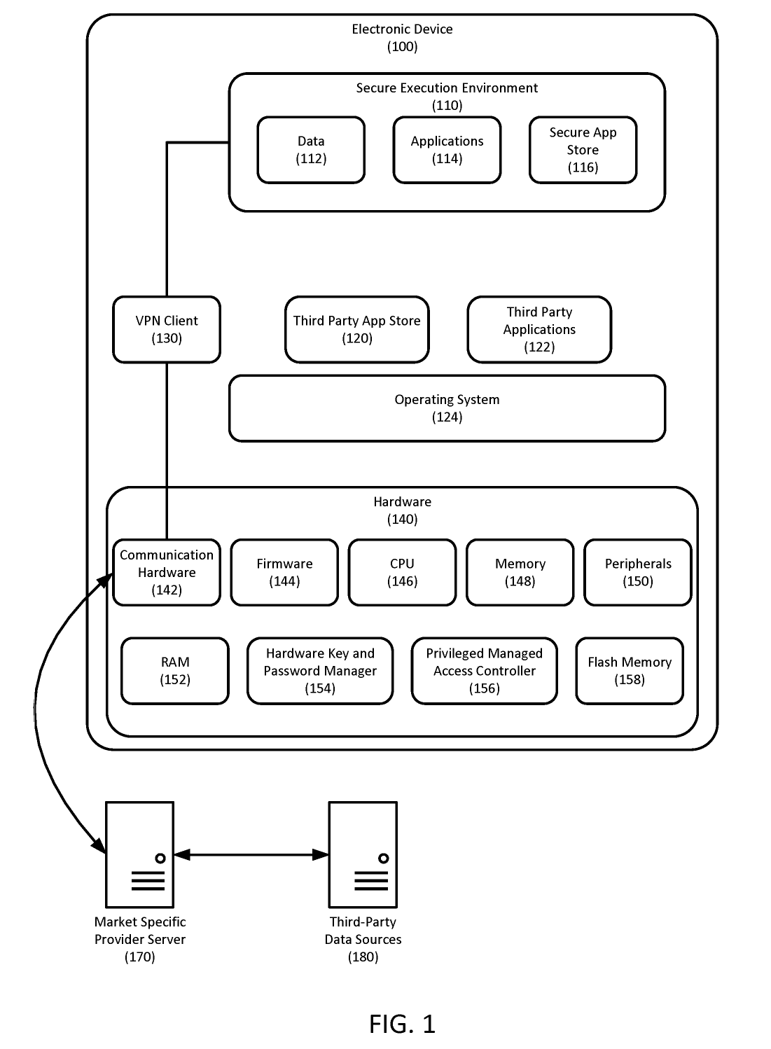

FIG. 1 depicts an architecture for a private market-specific provider electronic device according to an embodiment. Electronic device 100 may be, for example, a computer (e.g., workstation, desktop, laptop, notebook, tablet, etc.), a mobile electronic device such as a smartphone, an Internet of Things (IoT) appliance, etc. Electronic device 100 may provide secure execution environment 110, such as a secure sandbox, that may be secured by a market-specific provider, such as a financial institution. Secure execution environment 110 may store data 112 and may execute market-specific provider applications 114. Data 112 and the execution of market-specific provider applications 114 is secured from third-party applications 122 and processes that may be executed by electronic device 100, including third-party application (app) store 120 and operating system 124.

Secure execution environment may also include market-specific provider secure application store 116, which may allow for downloading market-specific provider applications 114 into secure execution environment 110.

Market-specific provider applications 114 in secure execution environment 110 may be custom applications that can request and consume data, and enrich results, without disclosing personal identifying information to third party applications 122, operating system 124, etc.

Hardware 140 may include communication hardware 142, such as radio frequency transceiver(s), firmware 144, central processing unit (CPU) 146, memory 148, peripherals 150, random access memory (RAM) 152, hardware key and password manager 154, privileged managed access controller 156, and flash memory 158. Firmware 144 may include market-specific provider firmware that may be provided by the market-specific provider. The market-specific provider firmware may be customized by the market-specific provider and may prevent other firmware from accessing data 112, activating hardware (e.g., turning on cameras, the microphone, etc.).

Communications between secure execution environment 110 and communication hardware 142 may be secured via a virtual private network 130 on electronic device 100. Thus, communications from and to communication hardware 142 (e.g., a transceiver) are secure. Thus, data flowing to and from secure execution environment 110 is not accessible to operating system 124 or any applications executed on electronic device 100.

Access to RAM 152 and flash memory 158 may be managed by the CPU 146. As noted above, firmware 144 may be programmed by the market-specific provider to manage access control.

Hardware key and password manager 154 may be controlled by operating system 124.

Hardware key and password manager 154 may be performed by VPN software provided by the market-specific provider.

In an embodiment, hardware 140 may be generically manufactured, configured and programmed by third-parties, and sold to multiple device makers. In another embodiment, hardware 140 may be generically manufactured and sold to multiple device makers, but is uniquely configured and programmed for a point-of-interaction electronic device. In still another embodiment, hardware 140 may be uniquely manufactured, configured and programmed only for a point-of-interaction device.

In an embodiment, the market-specific provider may provide electronic device 100, and may provide an operating system (not shown) within secure execution environment or for the point-of-interaction device.

In an embodiment electronic device 100 may provide International Mobile Equipment Identity (IMEI) and hardware identification protection, Media Access Control (MAC) identification spoofing protection, data extraction protection, file transfer protection, and location tracking protection. In an embodiment, the hardware (and at times include firmware) components may be specifically designed and manufactured in accordance with the market-specific provider whereby it can ensure that not even the hardware or firmware would snoop user’s personal data or allow leakage over to any communication channels such as cellular, WiFi, Bluetooth, etc. This is in contrast to generic devices that may not be locked down because they are not designed for consumer protection.

In an embodiment, electronic device 100 may provide a market-specific provider cellular connection that can only connect to market-specific provider (not shown).

In an embodiment, IMEI and hardware identification protection may be provided by tokenizing or masking the IMEI number.

MAC identification spoofing protection may be provided by randomizing the MAC identifier so that device 100 cannot be tracked.

Data extraction protection, file transfer protection, and location tracking protection may be provided by adding explicit user-permission function or by hardware on/off so that data cannot be improperly exfiltrated.

In an embodiment, hardware, such as cameras and microphones, cannot be enabled without express permission from the user.

Electronic device 100 may provide a built-in hardware virtual private network (VPN) client 130, random access memory (RAM) 152 with privileged access control, flash memory 158 with auto-encryption at rest, and privileged managed access controller 156.

VPN client 130 may be built-in to electronic device 100 and developed by the market-specific provider. Thus, the VPN tunnel is not accessible by anyone by the market-specific provider, such as market-specific provider server 170.

In an embodiment, the communication between electronic device 100 and market-specific provider server 170 may be via a MVNO (Mobile Virtual Network Operator), where market-specific provider server 170 carries the network traffic end to end completely.

Market-specific provider server 170 may interact with third party data sources, such as websites, search engines, applications, etc. In an embodiment, market-specific provider server 170 may interact via API.

The VPN Server (not shown) is also built and maintained by the market-specific provider. In short the whole end-to-end communication is entirely secured by the market specific provider.

Thus, in embodiment, the device – the hardware, software, and firmware – are all “locked down” to protect the user from snooping and having information collected and disseminated.

In an embodiment, any stealth video surveillance and eavesdropping capabilities in applications may be blocked at the operating system, hardware, and/or firmware level so that no applications can turn video, audio on by themselves without the user permitting them to turn on for his/her specific use at the moment.

Authentication, including multi-factor authentication (MFA) may be managed by the market-specific provider. Thus, in embodiments, the market-specific provider may enable different levels of authentication or authorization at device login level, app-level or task-level as the varying use cases may call for. Within secure execution environment 110, applications 114 may be deep-linked and authentication can be managed centrally as one system. For example, to see a checking account balance, the user may log into the device with a standard authentication (e.g., by providing a biometric). But in order to execute a higher risk transaction (e.g., a high dollar stock trade or wire transfer), the user or the bank may set up a stricter level of verification, e.g., require the user to answer further security questions.

This is in contrast to a generic electronic device, where each application manages its own authentication mechanism separately. Thus, there may be a lack of uniformity in way that each application performs authentication, leading to potential openings to snooping and data leakage.

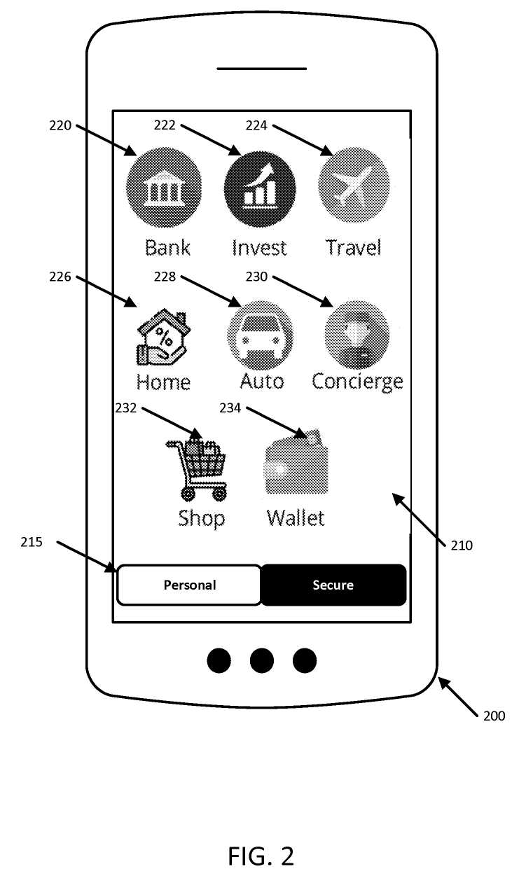

FIG. 2 depicts an exemplary implementation of a secure execution environment on a market-specific provider electronic device. Electronic device 200 may display, on display 210, option 215 to select a personal space or a secure space, such as a space provided by a financial institution, an employer, or other market-specific provider.

Display 210 may display a plurality of icons (e.g., 220, 222, 224, 226, 228, 230, 232, 234) that may be used to launch market-specific provider applications that execute in the secure execution environment. The icons may be tailored to services provided by a market-specific provider associated with the secure execution environment, such as a financial institution, an employer, etc.

Once launched, the user’s interactions with the market-specific provider applications, the data used, the results presented, etc. remain within the secure execution environment and are not shared with the operating system or other applications executed by electronic device 200.

All communications between the market-specific provider applications and a transceiver on electronic device 200 may use a VPN as described above. Data from the applications may be routed to a backend for the market-specific provider and then processed.

In an embodiment, the data may also be encrypted. If the data is encrypted, the receiving server would need a key to decrypt the data.

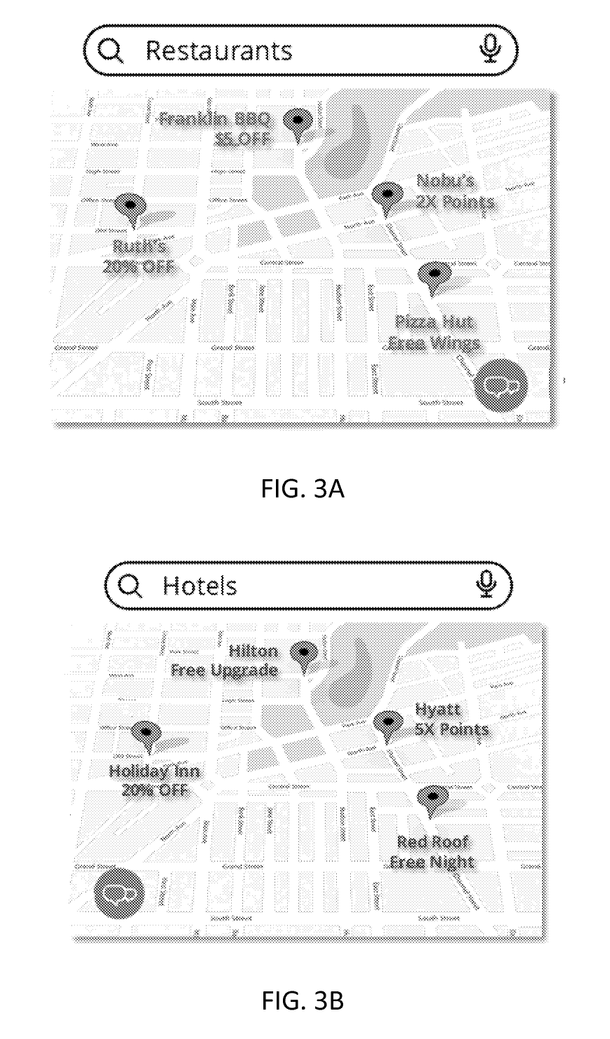

Embodiments may integrate benefit information into market-specific provider applications. For example, when a user searches for restaurants in a market-specific provider map application, offers or benefits, such as discounts, bonus offers, excusive opportunities, etc.) from the market- specific provider may be overlaid on the map. An example is provided in FIGS. 3A and 3B.

For example, in FIG. 3A, a user may launch a market-specific provider application, such as a custom map application, and may search for “restaurants.” Instead of just returning restaurants in the vicinity, the market-specific provider server may generate an overlay with offers (e.g., discounts or rewards) associated with the market-specific provider, and may identify those offers or rewards on the map.

The market-specific provider server may filter restaurants with deals, offers, rewards, etc. that match the user’s intent or spending patterns.

Similarly, in FIG. 3B, a user may search for “hotels” and may be presented with hotel offers (e.g., discounts or rewards) associated with the market-specific provider. Because the offers or benefits are overlaid over the map, and the identity of the searcher is obscured, the user’s searches cannot be tracked.

Although a map application is depicted in FIGS. 3A and 3B, it should be noted that this is exemplary only, and other applications, such as search engines, reservation engines, etc. may be used as is necessary and/or desired.

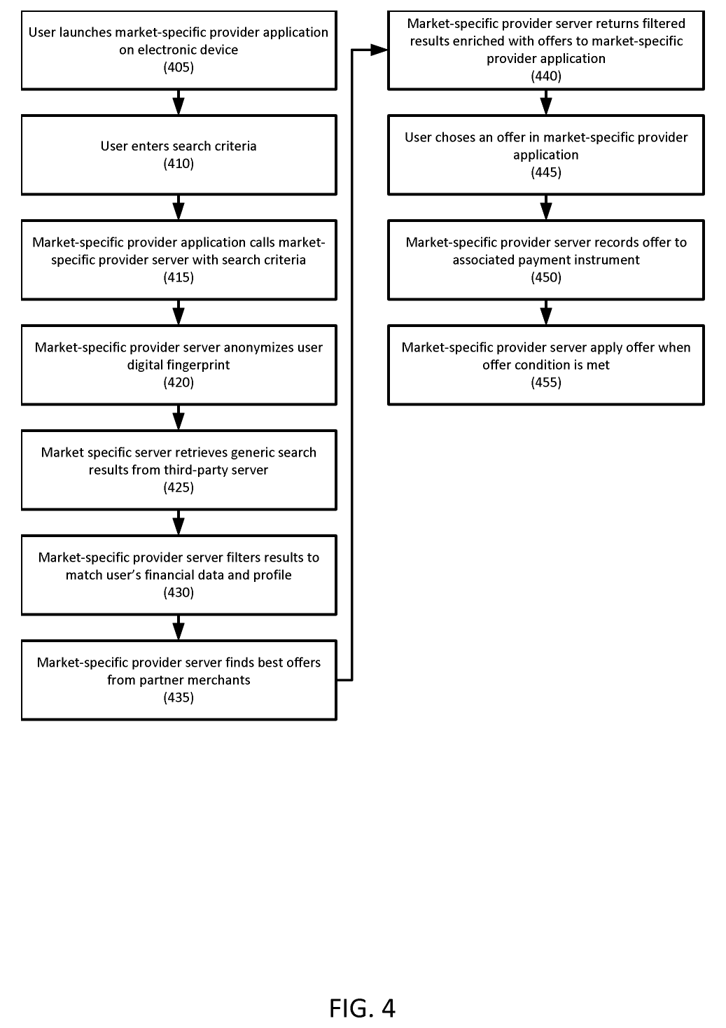

Referring to FIG. 4, a method for executing a search using an application in a secure execution environment of a market-specific provider electronic device is disclosed according to an embodiment.

In step 405, a user may launch a market-specific provider application, such as a market-specific provider mapping application, on the user electronic device. Other applications, such as search engines, reservation applications, etc. may be used as is necessary and/or desired.

In step 410, the user may enter a search. For example, the user may enter a search for restaurants, hotels, merchants, etc. within an area proximate to the user electronic device, or may specify a certain location by zip code, address, city, etc.

In step 415, the market-specific provider application may call a market-specific provider server, such as a server for a financial institution, with the search criteria.

In step 420, the market-specific provider server may anonymize the user’s digital fingerprint by removing any identifying information from the search (e.g., electronic device identifier, user identifiers, user account information, etc.).

In step 425, the market-specific provider server may retrieve generic search results from a third party server. For example, if the search is for restaurants in the user’s vicinity, the third party server may return an identification and location of restaurants.

In step 430, the market-specific provider server may filter the results to match the user’s financial data and profile. For example, the results may be filtered to include only partner merchants. Filtering, however, may be performed on any level that is necessary and/or desired.

In an embodiment, the market-specific provider server may identify the user’s intent and may filter the results according to the intent. For example, the market-specific provider server may combine information from the user’s transaction history, financial profile, spending patterns, products/services used, merchant data, etc. to predict the user’s intent of the search. The market-specific provider server may further use user search patterns, click-throughs, redemptions, etc. to further refine the intent.

In an embodiment, the market-specific provider server may deduce the user’s intent from the query. For example, the user may enter “find a good steak restaurant with the highest offers and book a reservation for two at 7 PM.” Thus, the user’s intent may be deduced from the user’s query, and the market-specific server may use this intent to select a restaurant for the user.

In step 435, the market-specific provider server may access a database of offers to identify the best offers available to the user from partner merchants. The offers may include discounts, reward points, benefits, etc.

In step 440, the market-specific provider server may enrich the search results with offers and may return the filtered results and offers to the market-specific provider application.

In step 445, the user may choose one of the offers presented by the market-specific provider application.

In step 450, the market-specific provider server may record the offer to an associated payment mechanism, such as a credit card.

In step 455, the market-specific provider server may apply the offer when the offer condition(s) are met, such as when a qualifying purchase is made using the associated payment mechanism.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In an embodiment, the processing machine may be a specialized processor.

In an embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

What is claimed is:

1. An electronic device, comprising:
a central processing unit;
a memory storing an operating system, a third-party application, and firmware;
a secure execution environment associated with a market-specific provider and comprising a market-specific provider application, wherein the operating system, the third-party application, and the firmware cannot access data in the secure execution environment; and
communications hardware in communication with the secure execution environment via a virtual private network (VPN);
wherein the VPN provides an interface for the market-specific provider application in the secure execution environment to securely communicate with a market-specific provider server without the operating system or the third-party application accessing user data in the secure execution environment.

2. The electronic device of claim 1, wherein the firmware further comprises market-specific provider firmware that is configured to prevent other firmware or the operating system from activating certain hardware.

3. The electronic device of claim 1, wherein the operating system is provided by the market-specific provider.

4. The electronic device of claim 1, wherein the market-specific provider application is configured to:
receive, from a user, a search;
call the market-specific provider server with the search;
receive results of the search, wherein the results are enriched with offers; and
receive a selection of one of the results.

5. A method, comprising:
receiving, by a market-specific provider application executed by an electronic device and from a user, a search;
calling, by the market-specific provider application, a market-specific provider server with the search;
anonymizing, by the market-specific provider server, a digital fingerprint for the user;
retrieving, by the market-specific provider server, generic search results from a third-party server;
filtering, by the market-specific provider server, the generic search results using financial data and/or a user profile for the user;
accessing, by the market-specific provider server, a database of offers, wherein the offers comprise discounts or reward point earning opportunities;
enriching, by the market-specific provider server, the filtered generic search results with the offers; and
returning, by the market-specific provider server, the filtered generic search results enriched with the offers to the market-specific provider application.

6. The method of claim 5, wherein the digital fingerprint comprises an electronic device identifier, a user identifier, and/or user account information.

7. The method of claim 5, wherein the market-specific provider application comprises a market-specific provider map application.

8. The method of claim 5, wherein the market-specific provider application comprises a market-specific provider search engine.

9. The method of claim 5, wherein the market-specific provider server filters the generic search results according to a user intent.

10. The method of claim 9, wherein the user intent is based on a transaction history for the user, a financial profile for the user, and/or spending patterns for the user.

11. The method of claim 9, wherein the user intent is deduced from the search.

12. The method of claim 5, wherein the market-specific provider application overlays the offers over the generic search results.

13. The method of claim 5, further comprising:
receiving, by the market-specific provider application, a selection of an offer;
recording, by the market-specific provider server, the offer to an associated payment mechanism; and
applying, by the market-specific provider server, the offer to a transaction involving a qualifying purchase.

14. A system, comprising:
a user electronic device comprising a computer processor and executing a market-specific provider application in a secure execution environment; and
a market-specific provider server in communication with the market-specific provider application via a virtual private network;
wherein:
the market-specific provider application is configured to receive, from a user, a search;
the market-specific provider application is configured to call the market-specific provider server with the search;
the market-specific provider server is configured to anonymize a digital fingerprint for the user;
the market-specific provider server is configured to retrieve generic search results from a third-party server;
the market-specific provider server is configured to filter the generic search results using financial data and/or a user profile for the user;
the market-specific provider server is configured to access a database of offers, wherein the offers comprise discounts or reward point earning opportunities;
the market-specific provider server is configured to enrich the filtered generic search results with the offers;
the market-specific provider server is configured to return the filtered generic search results enriched with the offers to the market-specific provider application; and
the market-specific provider application is configured to overlay the offers over the generic search results.

15. The system of claim 14, wherein the digital fingerprint comprises an electronic device identifier, a user identifier, and/or user account information.

16. The system of claim 14, wherein the market-specific provider application comprises a map application.

17. The system of claim 14, wherein the market-specific provider server filters the generic search results according to a user intent.

18. The system of claim 17, wherein the user intent is based on a transaction history for the user, a financial profile for the user, spending patterns for the user, and/or products or services used by the user.

19. The system of claim 17, wherein the user intent is deduced from the search.

20. The system of claim 14, wherein:
the market-specific provider application is configured to receive a selection of an offer;
the market-specific provider server is configured to record the offer to an associated payment mechanism; and
the market-specific provider server is configured to apply the offer to a transaction involving a qualifying purchase.
